(19) United States
(12) Patent Application Publication
(10) Pub. No.: US 2015/0120463 A1
(43) Pub. Date: Apr. 30, 2015

(54) SYSTEM AND METHOD FOR ADVERTISEMENT DISTRIBUTION

(71) Applicant: AUTONETTV MEDIA, Inc., American Fork, UT (US)

(72) Inventors: Robert H. Cannon, Sandy, UT (US); Sean P. Whiffen, Highland, UT (US); Lance E. Boldt, American Fork, UT (US)

(21) Appl. No.: 14/527,525

(22) Filed: Oct. 29, 2014

Related U.S. Application Data
(60) Provisional application No. 61/896,884, filed on Oct. 29, 2013.

(51) Int. Cl. G06Q 30/02

(52) U.S. Cl. CPC G06Q 30/0268
USPC 705/14.65

(57) ABSTRACT

The systems and methods described herein relate to digital library content management and distribution. Specifically, content providers, such as manufacturers and others, may provide and control the availability of content items to point-of-sale (POS) locations and other end-users. Various modules and/or portals allow for the uploading, distribution, and inclusion of content items in various locations and device settings within the POS location. In some embodiments, an automatic content replacement distribution module may dynamically update content items selected for distribution in POS locations in response to modifications or the replacement of the content items by the original content distributor.

### RELATED APPLICATIONS

This application claims priority to Unites Stated Provisional Patent Application No. 61/896,884, titled “SYSTEMS AND METHODS FOR ADVERTISEMENT DISTRIBUTION,” filed on Oct. 29, 2013, which is hereby incorporated by reference in its entirety so far as it is consistent or cumulative herewith.

### TECHNICAL FIELD

This application relates to systems and methods for providing regulated distribution of content and services.

### BRIEF DESCRIPTION OF THE DRAWINGS

Non-limiting and non-exhaustive embodiments of the disclosure are described herein, including various embodiments of the disclosure illustrated in the figures described below.

FIG. 1 illustrates a block diagram of one embodiment of a computer system for implementing the systems and methods of content management described herein.

FIG. 2A illustrates one embodiment of a graphical user interface for managing the distribution and display of electronic content items.

FIG. 2B illustrates another embodiment of a graphical user interface for managing the distribution and display of electronic content items.

FIG. 3 illustrates a block diagram of one embodiment of content items being added to a content library named “drive” operated by AutoNetTV.

FIG. 4 illustrates a block diagram of one embodiment of content items being selectively added to content compilations from various point-of-sale (POS) portals.

FIG. 5 illustrates one embodiment of a POS location utilizing various POS portals to selectively display content items.

FIG. 6 illustrates an example of a simplified accessibility assignment of a content item, according to one embodiment.

FIG. 7 illustrates another simplified accessibility assignment of a content item, according to one embodiment.

FIG. 8 illustrates a block diagram of a content provider (e.g., a manufacturer) providing content to a cloud-based content library that is accessible to POS entities via distribution equipment for display on a POS display.

FIG. 9 illustrates a block diagram of one embodiment of a hierarchical structure of POS locations and the distribution of content.

FIG. 10 illustrates a block diagram similar to that in FIG. 9 with content items from an industry content item library being made selectively accessible to POS locations and entities that satisfy the accessibility level requirements associated with the content items within the content library.

FIG. 11 illustrates a flow diagram of one embodiment of a method for implementing an automatic content replacement distribution schema.

FIG. 12 illustrates a flow diagram of another embodiment of a method for managing content items and their distribution and usage within a POS location.

### DETAILED DESCRIPTION

The systems and method described herein relate to the management of content distribution. In various embodiments, an end-user, such as a point-of-sale (POS) entity or location, is able to select content items from a content library for distribution within and associated with a POS location. Content providers are able to selectively upload content items for distribution and regulate the usage of the content items by POS entities as desired.

For example, in various embodiments an electronic content delivery system may provide a lobby TV program that replaces regular TV programming in a lobby or other waiting area of a POS location. The lobby TV programming may provide content specific to the POS location, entertainment content, information content, and/or other content such as 3D animations, advertisements, illustrations, promotional content, images, rebates, special offerings, coupons, etc. The lobby TV programming may exclude competitor advertisements, offensive content, and/or other content items adverse to the interests of the POS location or entity. Accordingly, the lobby TV programming may be preferable to regular TV programming for a POS location or entity.

In some embodiments, the content delivery system may allow a POS entity to select from and customize a library of content items to create a compilation of content items for a digital, possibly dynamic, menu board of available products and services. The menu board may be adapted and adjusted at any time and may be dynamically adjusted based on current promotions or specials offered by the POS entity, manufacturers, distributors, and/or other parties. In some embodiments, the menu board may dynamically adjust based on other local conditions, such as availability of employees, seasonal conditions, weather conditions, and the like.

As an example, an automotive POS location may select and customize content items from a content library to create a services list, identify current promotions, and list pricing. If a manufacturer updates the content library to reflect a new discount, the dynamic menu, in some embodiments, may be automatically updated to reflect the current promotion and potentially an adjustment in price associated with the promotion.

In some embodiments, the content delivery system may also allow a POS entity to select content items from a content library for inclusion in a webpage or other digital signage, advertisement, promotion, social media page, or the like. The selected content or compilation of content may be updated dynamically based on the original content provider's modifications, updates, or replacements of the selected content items.

For example, a POS merchant selling BBQ grills may select an advertisement content item from the content library for inclusion in the POS merchant's webpage. The selected content item may include images, videos, and/or text associated with the marketed product. If the BBQ goes on sale for the fall, the manufacturer may update (i.e., replace/modify) the content item with a new content item reflecting the promotional pricing. The system may implement an automatic content replacement distribution schema in which the removed content item is automatically deleted from the POS merchant's webpage and replaced with the updated content item. This seamless automatic content replacement distribution system allows POS entities to stay up to date with the latest advertisements, promotions, informational content, videos, text, images, audio, and other content provided by content distributors, such as manufacturers, distributors, wholesalers, and other interested parties.

According to various embodiments, industry manufacturers and other content distributors may upload and manage content that is made available at end-user locations, such as POS locations. For example, an oil manufacturer may obtain an account on the content delivery system and upload any number and type of content items to one or more content libraries. The oil manufacturer may control the distribution and availability of the content items by creating a rule set or associating a set of properties with each content item. The rule set or properties may limit the availability of the content items to only those end-users or POS entities that satisfy the assigned properties.

For instance, the accessibility of the content item may be limited to only those content requestors that have a contractual relationship with the content provider, only those content requestors that market at least one of a service associated with the content provider and a product associated with the content provider, and/or only those end-users utilizing a specific type or types of devices.

In various embodiments, the content items may only be accessible by certain employees, managers, supervisors, potential consumers, loyalty member consumers, etc. Content provides may limit the accessibility based on geographical considerations, accessing device type, start and end dates, black-out dates, consumer qualifications, POS qualifications, etc. For example, certain content items, such as discounts and promotional content items, may be restricted to only those POS locations satisfying certain marketing, sales, certification, and/or training criteria.

In various embodiments, the manufacturer or other content provider may update (i.e., modify or replace) content items within the content library. According to various embodiments, the content management system may provide an automatic content replacement distribution service. This service allows modifications of content items to be automatically propagated to end-users without necessarily requiring action on the part of end-users. In some embodiments, the propagation of modified content may occur periodically, based on a refresh schedule, when equipment is power cycled, on demand of the content provider, and/or on demand of the end-user.

As an example, a POS location may select a monthly promotion as a content item for display on an interactive kiosk within the POS location. The monthly promotion may have been originally uploaded by a manufacturer and may be modified (i.e., replaced) each month with a new promotion. In various embodiments, modifications to the monthly promotion will be updated on the kiosks at the POS location automatically and without the POS entity having to do anything. This provides a significant improvement over previous systems in which content providers had little or no control over when or how the end-users would update content items.

The present content delivery system provides greater control to the content providers regarding how, when, where, and who is allowed to view content items in a POS location. In other embodiments, the content providers rely heavily on the discretion of POS entities as to what content is displayed and when. Moreover, the end-users are benefited in that they do not have to worry about whether or not the content items, such as current promotions, educational programming, discounts, product availability, and the like, are accurate and up to date. Rather, the end-users can rely on the automatic content replacement distribution to keep all content items up to date continuously, based on periodic automatic refreshes, or manual refreshes.

The manufacturer or other content provider may specify the device type for which their content is available for display. In various embodiments, when any asset (i.e., content item) is uploaded, such as videos, images, audio files, etc., the manufacturer or other content provider may add properties or variables specifying the accessibility level of the content item. Thus, a content provider may specify that a particular content item is for use exclusively on websites, only on tablets, only on non-interactive displays, only on interactive display, only on menu boards, and/or any combination of the above. For example, some content may only be intended for interactive displays, while other content may be intended for lobby entertainment, and still other content may be intended for remote access via a website. In some embodiments, some content is only made accessible to employee devices, such as employee kiosks, training stations, employee break rooms or stock rooms, and/or other controlled areas. Such content items may be specifically configured to assist an employee of a POS location in performing a specific duty, help induce customers to make a purchase, or provide training to the employee.

As used herein, a content provider may be a manufacturer, distributor, wholesaler, franchisor, corporate headquarters, service provider, or other party interested in training, compliance, or sales within a POS location. As used herein, POS entities and POS locations may be used interchangeably in many instances and a POS entity is only intended to be different from a POS location inasmuch as it is contextually required. The term “patron” should be broadly construed to include anyone downstream from the content provider in the distribution and sales chain, including, in the case of a manufacturer one or more employees, customers, potential customers, and/or other entities within the distribution system and/or the POS location.

In some embodiments, a POS entity may select content items from a library of content items managed and distributed by the presently described content management system. The POS entity may select content items to create a content compilation. In some embodiments, content items from the managed content library may be mixed with content items available from third parties which may or may not be outside the control of the presently described content management system. For example, in one embodiment, a POS entity may select an uninterrupted streaming video service to provide entertainment in a lobby or waiting area. The POS entity may select content items from a library of content items to create a content compilation for insertion as interruptions to the streaming video and/or as overlays to the streaming video. More specifically, a POS entity may select content items for insertion as interruptions in a third party-controlled streaming video service that may or may not be paused during the content item interruptions. As a specific example, a POS entity may select content items to be displayed instead of the standard commercials displayed in a broadcast television show or as commercials added to an otherwise uninterrupted video stream.

Additionally, as used throughout this disclosure, including the claims, terms such as “first” and “second” are not intended to indicate a temporal relationship. Rather, the terms “first,” “second,” and the like are used only to facilitate referencing the subsequent subject. For example, a “first content item” is simply a content item with the adjective “first” added to provide reference in subsequent references to the content item. Thus, it would not be contradictory to add a first content item to a content library that already includes a plurality of content items, including second, fourth, and sixth content items, even if no mention is ever made of, nor there necessarily exists, third and fifth content items.

The various systems and methods described herein may include and/or utilize processors, computers, data stores, memory, databases, electronic libraries, and networking and other communication devices, and may utilize a wide variety of protocols and programming languages. A “content library” may inherently, physically, and/or logically be divided into more than one content library, and multiple “different” content libraries may be logically unique but be embodied, managed, and/or physically stored as a single content library.

Embodiments may include various steps, which may be embodied in machine-executable instructions to be executed by a computer system. A computer system includes one or more general-purpose or special-purpose computers (or other electronic devices). The computer system may include hardware components that include specific logic for performing the steps or may include a combination of hardware, software, and/or firmware.

Embodiments may also be provided as a computer program product including a computer-readable medium, e.g., a non-transitory computer-readable medium, having stored thereon instructions that may be used to program a computer system or other electronic device to perform the processes described herein. The computer-readable medium may include, but is not limited to: hard drives, floppy diskettes, optical disks, CD-ROMs, DVD-ROMs, ROMs, RAMs, EPROMs, EEPROMs, magnetic or optical cards, solid-state memory devices, or other types of media/computer-readable media suitable for storing electronic instructions.

Computer systems and the computers in a computer system may be connected via a network. Suitable networks for configuration and/or use as described herein include one or more local area networks, wide area networks, metropolitan area networks, and/or Internet or IP networks, such as the World Wide Web, a private Internet, a secure Internet, a value-added network, a virtual private network, an extranet, an intranet, or even standalone machines which communicate with other machines by physical transport of media (a so-called “sneakernet”). In particular, a suitable network may be formed from parts or entireties of two or more other networks, including networks using disparate hardware and network communication technologies.

One suitable network includes a server and several clients; other suitable networks may contain other combinations of servers, clients, and/or peer-to-peer nodes, and a given computer system may function both as a client and as a server. Each network includes at least two computers or computer systems, such as the server and/or clients. A computer system may include a workstation, laptop computer, disconnectable mobile computer, server, mainframe, cluster, so-called “network computer” or “thin client,” tablet, smart phone, personal digital assistant or other hand-held computing device, “smart” consumer electronics device or appliance, medical device, or combination thereof.

The network may include communications or networking software, such as the software available from Novell, Microsoft, Artisoft, and other vendors, and may operate using TCP/IP, SPX, IPX, and other protocols over twisted pair, coaxial, or optical fiber cables, telephone lines, radio waves, satellites, microwave relays, modulated AC power lines, physical media transfer, and/or other data transmission “wires” known to those of skill in the art. The network may encompass smaller networks and/or be connectable to other networks through a gateway or similar mechanism.

A computer system may include one or more processors, memory, and/or various input devices and/or output devices. The processor may include a general-purpose device, such as an Intel®, AMD®, or other “off-the-shelf” microprocessor. The processor may include a special-purpose processing device, such as an ASIC, SoC, SiP, FPGA, PAL, PLA, FPLA, PLD, or other customized or programmable device. The memory may include static RAM, dynamic RAM, flash memory, one or more flip-flops, ROM, CD-ROM, disk, tape, magnetic storage, optical storage, or other computer storage medium. The input device(s) may include a keyboard, mouse, touch screen, light pen, tablet, microphone, sensor, or other hardware with accompanying firmware and/or software. The output device(s) may include a monitor or other display, printer, speech or text synthesizer, switch, signal line, or other hardware with accompanying firmware and/or software.

The computer systems may be capable of using a floppy drive, tape drive, optical drive, magneto-optical drive, or other means to read a storage medium. A suitable storage medium includes a magnetic, optical, or other computer-readable storage device having a specific physical configuration. Suitable storage devices include floppy disks, hard disks, tape, CD-ROMs, DVDs, PROMs, random access memory, flash memory, and other computer system storage devices. The physical configuration represents data and instructions which cause the computer system to operate in a specific and predefined manner as described herein.

Suitable software to assist in implementing the invention is readily provided by those of skill in the pertinent art(s) using the teachings presented here and programming languages and tools, such as Java, Pascal, C++, C, database languages, APIs, SDKs, assembly, firmware, microcode, and/or other languages and tools. Suitable signal formats may be embodied in analog or digital form, with or without error detection and/or correction bits, packet headers, network addresses in a specific format, and/or other supporting data readily provided by those of skill in the pertinent art(s).

Several aspects of the embodiments described will be illustrated as software modules or components. As used herein, a software module or component may include any type of computer instruction or computer-executable code located within a memory device. A software module may, for instance, include one or more physical or logical blocks of computer instructions, which may be organized as a routine, program, object, component, data structure, etc., that perform one or more tasks or implement particular abstract data types.

In certain embodiments, a particular software module may include disparate instructions stored in different locations of a memory device, different memory devices, or different computers, which together implement the described functionality of the module. Indeed, a module may include a single instruction or many instructions, and may be distributed over several different code segments, among different programs, and across several memory devices. Some embodiments may be practiced in a distributed computing environment where tasks are performed by a remote processing device linked through a communications network. In a distributed computing environment, software modules may be located in local and/or remote memory storage devices. In addition, data being tied or rendered together in a database record may be resident in the same memory device, or across several memory devices, and may be linked together in fields of a record in a database across a network.

Much of the infrastructure that can be used according to the present invention is already available, such as general-purpose computers, computer programming tools and techniques, computer networks and networking technologies, digital storage media, authentication, access control, and other security tools and techniques provided by public keys, encryption, firewalls, and/or other means.

The embodiments of the disclosure may be understood by reference to the drawings, wherein like elements are designated by like numerals throughout. In the following description, numerous specific details are provided for a thorough understanding of the embodiments described herein. However, those of skill in the art will recognize that one or more of the specific details may be omitted, or other methods, components, or materials may be used. In some cases, operations are not shown or described in detail in order to avoid obscuring more important aspects of the disclosure.

Specific descriptions of industries, content providers, manufacturers, end-users, employees, and/or other entities providing or consuming content are provided by way of example only. Specifically, examples associated with the automotive, retail, and furniture markets are provided as specific examples and are not intended to limit the disclosure in any way. The presently described systems and methods can be utilized or adapted for utilization in any of a wide variety of entities, including, but not limited to, manufacturers, service providers, distributors, wholesalers, retail sellers, outlet sellers, employers, employees, consumers, and others in any of a wide variety of industries and service areas.

Furthermore, the described features, operations, or characteristics may be combined in any suitable manner in one or more embodiments. The order of the steps or actions of the methods described in connection with the embodiments disclosed may be changed as would be apparent to those skilled in the art. Thus, any order in the drawings or detailed description is for illustrative purposes only and is not meant to imply a required order, unless specified to require an order.

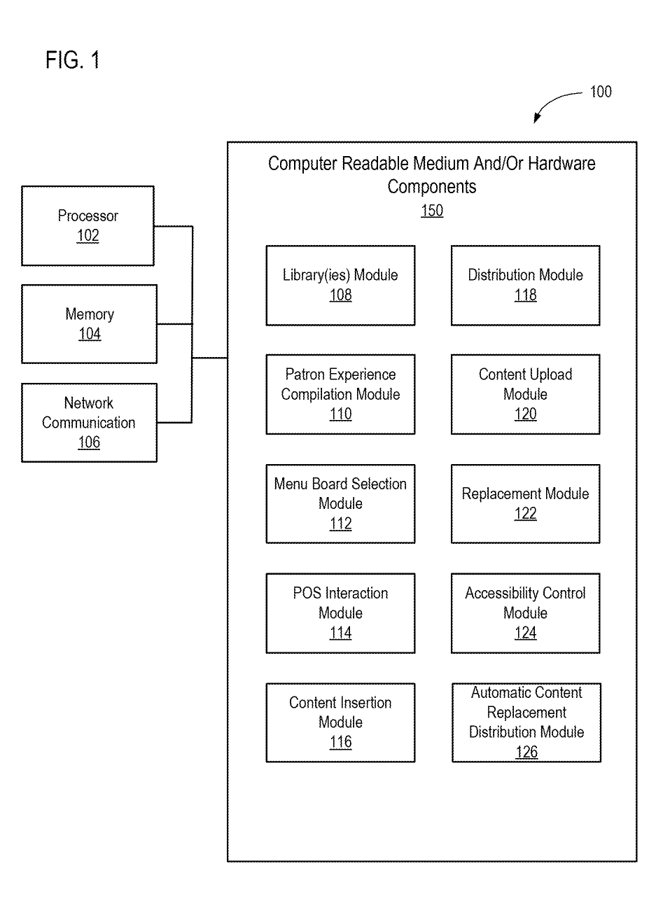

FIG. 1 illustrates a block diagram of one embodiment of a computer system 100 for implementing the systems and methods of content management described herein. As illustrated, a content management system may include a processor 102, memory 104, and network communication equipment 106. A communicatively coupled computer readable medium and/or various hardware subsystems 150 may include one or more of the illustrated modules to perform one or more of the various functions described herein. It is appreciated that the illustrated breakdown of module functionality is arbitrary and any number of modules may be combined into a single module and/or any one (or more) of the illustrated modules may be further subdivided into a plurality of sub-modules.

A library module 108 may be configured to store, manage, retrieve, and/or otherwise facilitate distribution and storage of content items, such as audio clips, video clips, images, interactive mini-programs, educational content, electronic games, interactive programming applications, and/or any other digital content that can be used, viewed, and/or otherwise interacted with on a tablet, television, computer, mobile phone, speaker system, haptic feedback system, and/or other electronic device. A patron experience compilation module 110 may be configured to allow for the creation of a compilation of content items from a library of content items. The patron experience module 110 may be useful to create a content compilation for a lobby or waiting room display or audio system that includes selected content deemed non-adverse to the interest of the end-user or POS entity and affiliates.

A menu board selection module 112 may be configured to allow for the selection of content for an electronic display of services and/or products available at the POS location. A graphical user interface, a list of available content, and customization options may facilitate a POS entity in creating a content compilation for display on an electronic menu board. For example, in an automotive industry the menu board may include automotive services, such as oil changes, tire rotations, fluid changes, various upgrade options for common services, and/or the like. The menu board may be customized with content items provided by manufacturers of associated products and services, promotions, pricing information, wait times, current offerings and availability, and/or other content.

A POS interaction module 114 may be configured to allow for the selection of at least one interactive content item associated with a service and/or product available at the POS location. The interactive content item may be a product or service educational video, an interactive questionnaire, a survey, a vehicle customization kiosk, a service customization kiosk, a game, an infotainment application, and/or other interactive multimedia content or application.

A content insertion module 116 may be configured to allow a POS entity to insert dynamic content items (i.e., content items that are automatically updated via an automatic content replacement distribution schema, which in some embodiments may include potentially all content items) from a content library into content compilations. The content compilations may include, but are not limited to, websites and other content distribution channels.

A distribution module 118 may be configured to distribute the content items from the library of content items to the content requestors according to the content selections of a POS entity and/or selected/created content compilations. A content upload module 120 may be configured to allow each of a plurality of content providers to upload a plurality of content items to the content library. Uploaded content items may be tagged and/or associated with various rule sets, properties, etc. via an accessibility control module 124 to limit access based on any of the various criteria described herein.

A replacement module 122 may allow content providers to replace a previously uploaded content item with a replacement content item (i.e., a modified content item), such that the replaced content item is removed from the library of content items. The automatic content replacement distribution module 126 may automatically update the content compilations and/or individual content items selected/created by POS entities and/or other end-users. The automatic update may comprise seamlessly substituting the replacement content item in place of the removed content item.

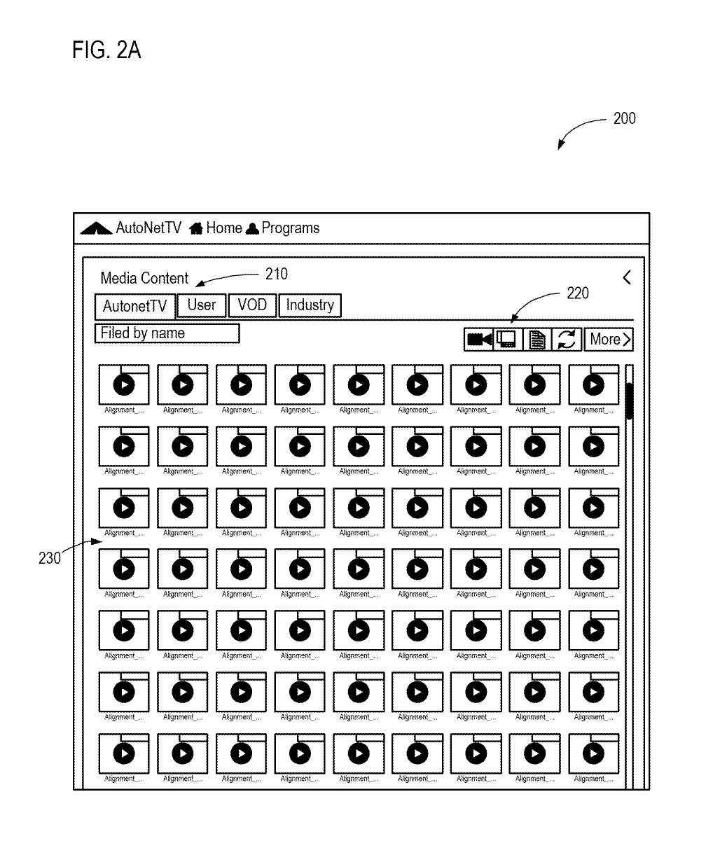

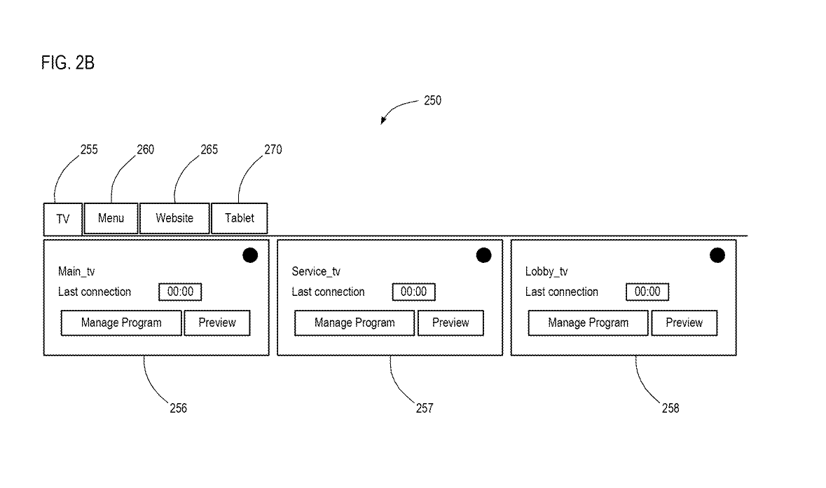

FIG. 2A illustrates one embodiment of a graphical user interface 200 for managing the distribution and display of electronic content items 230. As illustrated, tabs 210 may allow a POS entity to access industry online content within an industry content library (i.e., a content repository). Any of a wide variety of content item types may be available for selection. As in previous embodiments, some content may have restricted availability based on property selections associated with each content item.

FIG. 2B illustrates another embodiment of a graphical user interface 250 for managing the distribution and display of electronic content items. As illustrated, various tabs allow the POS entity to makes content selections for a lobby or waiting area TV 255, a digital menu or signage 260, a website 265, and interactive kiosks or tablets 270. Under the current selection, TV 255, the POS entity (or other end-user) is able to manage the program for, preview, and/or otherwise control the delivered content independently for three different TVs 256, 257, and 258.

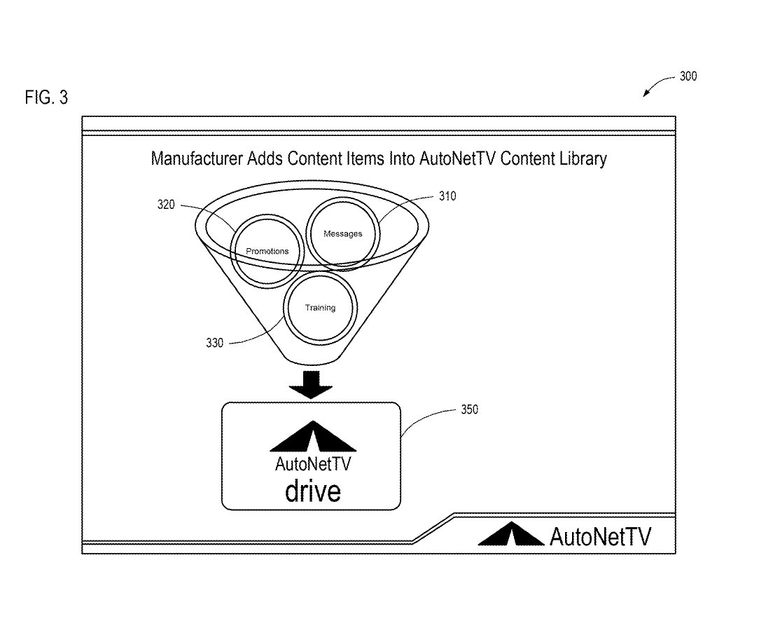

FIG. 3 illustrates a block diagram 300 of one embodiment of content items, including messages 310, promotions 320, and training 330 being added to a content library 350 named “drive” operated by AutoNetTV. Each of the content items may be tagged with one or more properties to manage the accessibility level of the content item. For example, the training content item 330 may be intended for employees of POS locations, while the promotions 320 may be intended for display on websites and/or lobby TVs. Messages 310 may be specifically tailored as part of an interactive application on a kiosk or tablet device within a POS location.

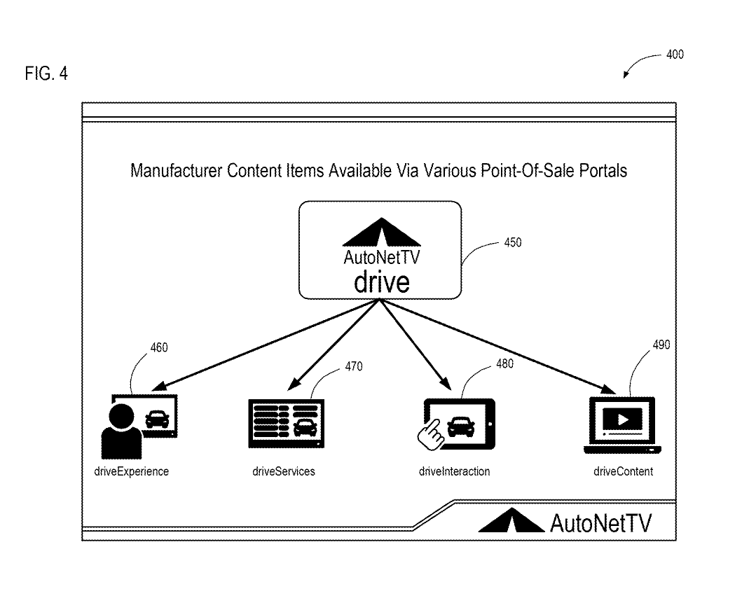

FIG. 4 illustrates a block diagram 400 of one embodiment of content items being selectively added to content compilations from various POS portals. As illustrated, POS entities may access the content library 450 via a driveExperience portal 460 configured to function as a patron experience compilation module described herein. The driveExperience 460 module may allow a POS entity to select content for public display in locations such as a lobby, waiting area, general shopping area, and/or other semi-public or public viewing location. A subset of the content items stored and/or accessible via the content library 450 may be specifically intended for the driveExperience portal 460, while other content items may be specifically excluded from access via the driveExperience portal 460.

A driveServices portal 470 may allow for the selection of content for an electronic display, such as a menu board. A drivelnteraction portal 480 may allow for the selection of interactive content available via the content library 450. Finally, the driveContent portal 490 may allow the POS entity to insert dynamic content items from the content library 450 into content compilations. Any of the various content items may be automatically updated via an automatic content replacement distribution function in response to a content provider, such as a manufacturer, updating or replacing a selected content item.

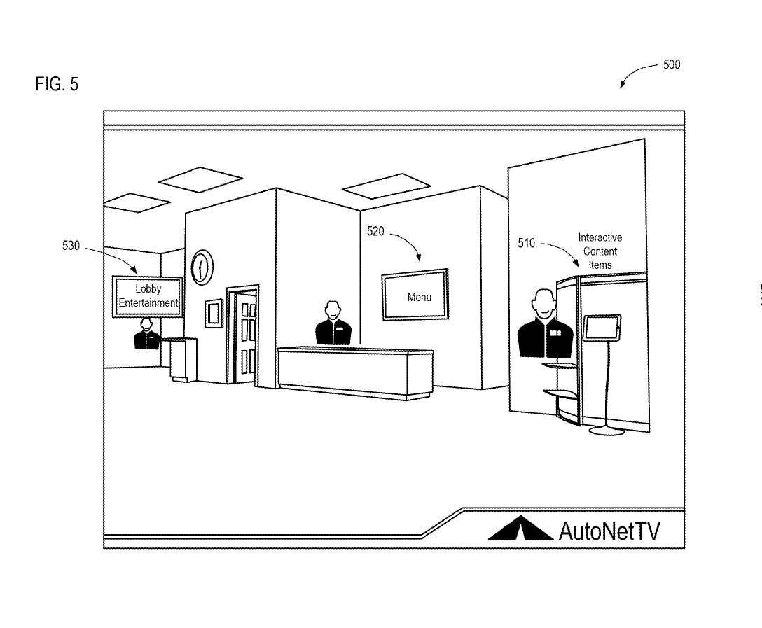

FIG. 5 illustrates one embodiment of a POS location 500 utilizing various POS portals to selectively display content items. A lobby TV 530 may be used as a distribution outlet for content items selected via a patron experience compilation module or portal. A menu display 520 may be used to display content items selected via a menu board selection module or portal. Finally, interactive content items may be distributed via an interactive tablet kiosk 510. The interactive content items may be managed and selected via a POS interaction module. In various embodiments, the availability of customizable and automatically updating content items allows for a virtual POS location in which real-time updated content items are made available in a user-friendly fashion.

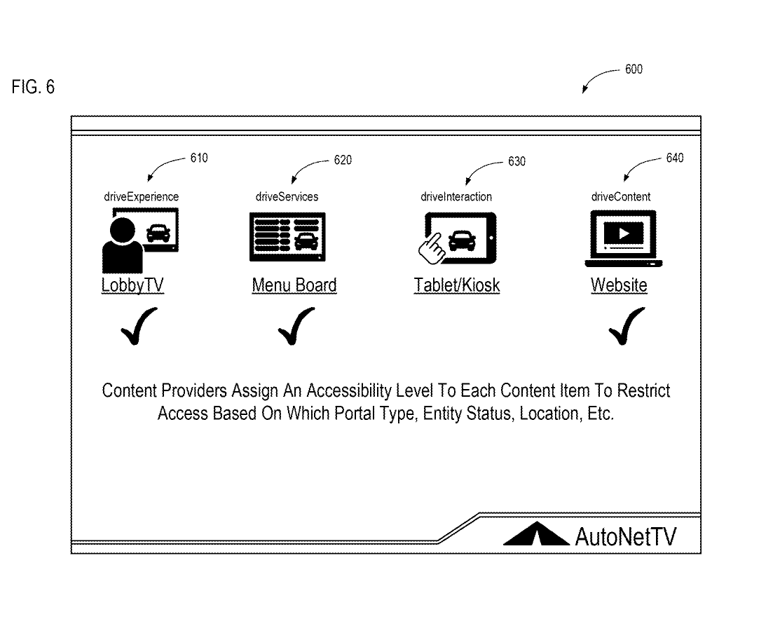

FIG. 6 illustrates an example of a simplified accessibility assignment 600 of a content item, according to one embodiment. As illustrated, content providers may assign accessibility levels to each content item (or set of content items) to restrict and/or limit access to the content item based on which portal type is being used by the POS entity, a status of the entity, a location of the entity, and/or for other criteria described herein. As illustrated, the content item has been approved for distribution on a lobby TV 610, a menu board 620, and a website 640. However, the content has been restricted from being used on a tablet or kiosk 630.

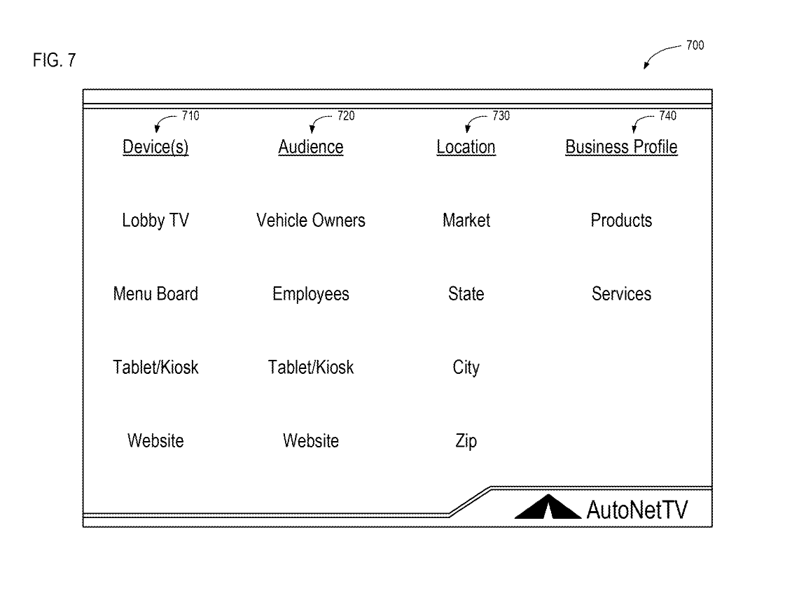

FIG. 7 illustrates another simplified accessibility assignment 700 of a content item, according to one embodiment. In the illustrated table, the types of devices on which the content item may be viewed are listed, at 710. The audience for which the content item is intended may be suggested or enforced as mandatory, at 720. Locations in which the manufacturer or other content provider approves for distribution of the content item may be based on a market, state, city, and/or zip code, at 730. Finally, the content item may be categorized as either products or services, at 740.

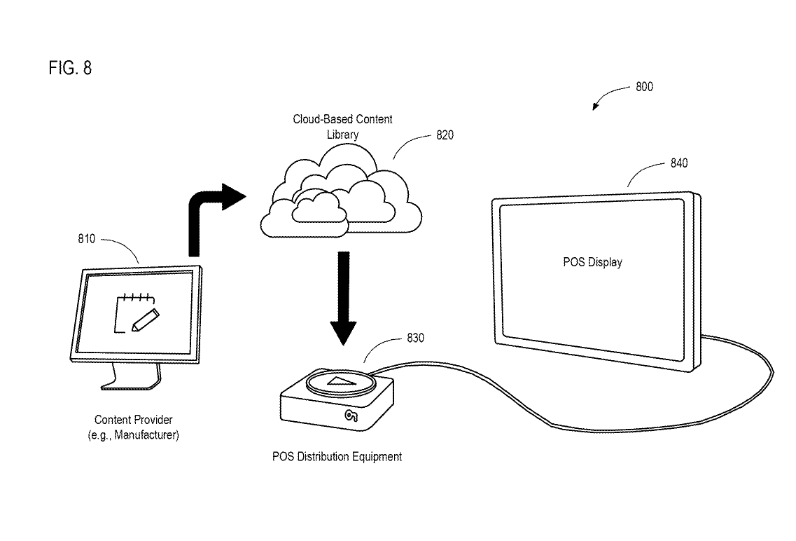

FIG. 8 illustrates a block diagram 800 of a content provider (e.g., a manufacturer) 810 providing content to a cloud-based content library 820 that is accessible to POS entities via POS distribution equipment 830 for display on a POS display 840. According to various embodiments, the POS distribution equipment 830 may provide the graphical user interfaces and/or various functionalities associated with the content management systems and methods described herein. In some embodiments, the cloud-based content library is part of a cloud-based system configured to implement the various functionalities and interfaces described in conjunction with the systems and methods herein.

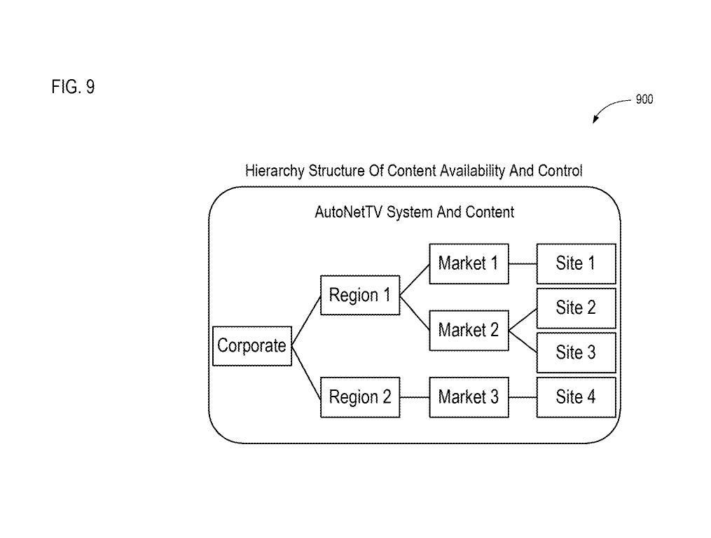

FIG. 9 illustrates a block diagram 900 of one embodiment of a hierarchical structure of POS locations and the distribution of content therein. As illustrated, content distribution may be done on a top-down approach in which the corporate content is selectively made available to region managers, various markets, and ultimately a subset of the sites 1-4. In such an embodiment, a manufacturer or other content provider has little or no immediate control over how the content items are distributed and disseminated. For the most part, the distribution of content items prepared by the corporate offices will trickle down, in semi-permanent form, until the POS entities (Site 1, Site 2 . . . Site 5) are given some subset of the approved content items. Thus, again the manufacturers traditionally have little or no control regarding how their content items are used by end-users. In contrast, the presently described systems and methods increase control and restrictions of the content items and allow for automatic updating of content items.

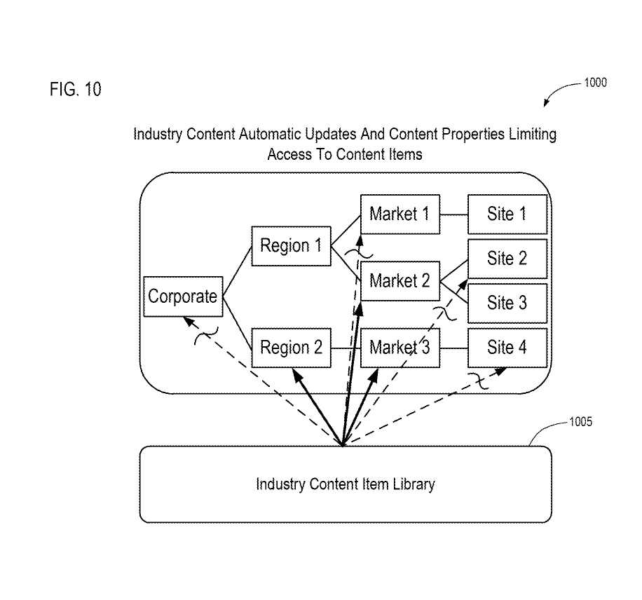

FIG. 10 illustrates a block diagram 1000 similar to that in FIG. 9 with content items from an industry content item library 1005 being made selectively accessible to POS locations and entities that satisfy the accessibility level requirements associated with the content items within the content library.

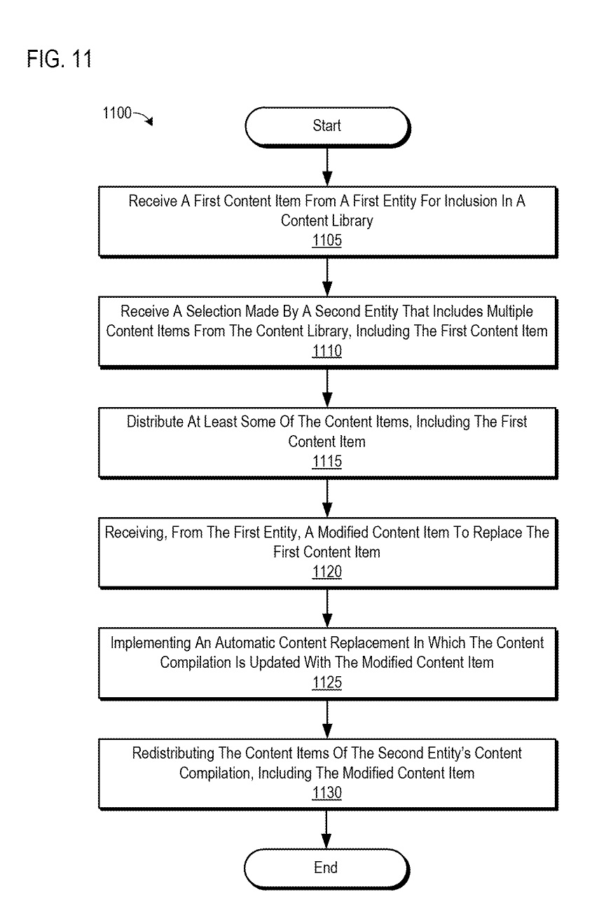

FIG. 11 illustrates a flow diagram of one embodiment of a method 1100 for implementing an automatic content replacement distribution schema. A first content item may be received, at 1105, from a first entity for inclusion in a library of content items. A selection of the first content item may be received, at 1110, from a second entity as part of a selection of a plurality of content items. At least some of the content items may be distributed, at 1115. The first entity may provide a modified content item, at 1120, to replace the first content item.

As previously described, an automatic content replacement distribution schema may automatically update, at 1125, content compilations selected by various POS entities with the new, modified content item and delete the removed/replaced content item from the various content compilations. Various content items, including the modified content item, may be redistributed, at 1130, to the appropriate POS locations.

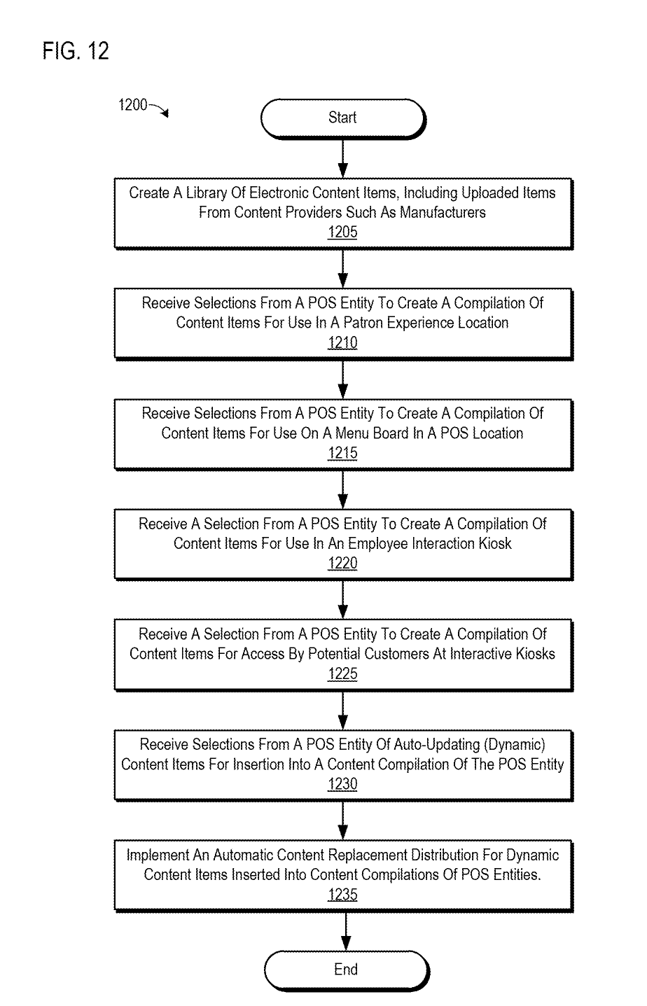

FIG. 12 illustrates a flow diagram of another embodiment of a method 1200 for managing content items and their distribution and usage within POS locations. According to various embodiments, a library of electronic content items may be created, at 1205, by content providers, such as manufacturers, uploading content to the content library. One or more POS entities may make selections from the content library, at 1210, to create compilations of content items for use in a patron experience location, such as a shopping area, waiting area, lobby area, and/or the like.

One or more POS entities may make selections from the content library, at 1215, to create content compilations for use on a menu board in a POS location. Similarly, one or more POS entities may make selections from the content library, at 1220, to create content compilations for use in an employee interaction kiosk and/or for customer or potential customer interaction kiosks, at 1225. A POS entity may also make selections, at 1230, of dynamic content configured to be auto-updated by the manufacturer for inclusion of the content in one or more portals or modules, as described herein. The system may then implement an automatic content replacement distribution schema by dynamically modifying/replacing content items with the latest, most up-to-date content items seamlessly and without necessarily requiring the end-user or POS entity to do anything.

While various aspects and embodiments have been disclosed herein, other aspects and embodiments will be apparent to those skilled in the art. The various aspects and embodiments disclosed herein are for purposes of illustration and are not intended to be limiting.

What is claimed is:

1. An electronic content delivery system, comprising:
at least one network communication component configured to receive network communications from a point-of-sale (POS) entity;
a processor configured to process network communications from the POS entity;
a data store for storing data objects, including electronic content items;
a first library of electronic content items for presentation to patrons of a POS location associated with the POS entity;
a patron experience compilation module configured to allow for the creation of a compilation of content items from the first library of content items that excludes content items adverse to the interests of a POS entity;
a menu board selection module configured to allow for the selection of content for an electronic display of at least one of services available at the POS location and products available at the POS location;
a POS interaction module configured to allow for the selection of at least one interactive content item associated with at least one of a service available at the POS location and a product available at the POS location;
a set of dynamic content items for insertion in content compilations, including at least one dynamic content item provided by an entity independent from the POS entity;
a content insertion module configured to allow the POS entity to insert dynamic content items into content compilations, including at least one content item provided by the independent entity; and
an automatic content replacement distribution module configured to dynamically update a dynamic content item in the POS entity's content compilation in response to a modification of the dynamic content item by the independent entity.

2. The system of claim 1, wherein content items of the electronic content delivery system comprise at least one of video, audio, and images.

3. The system of claim 1, wherein the patron comprises at least one of a customer, a potential customer, and an employee of the POS entity.

4. The system of claim 1, wherein the dynamic content item comprises one of a coupon, a promotion, an advertisement, a rebate, and a special offering.

5. The system of claim 1, wherein the independent entity comprises a manufacturer of a product sold at the POS location.

6. The system of claim 1, wherein the patron experience compilation module is configured to allow for the creation of a compilation of content items intended for display in at least one of a lobby of the POS location and a waiting area of the POS location.

7. The system of claim 1, wherein the POS interaction module is configured to allow for the selection of at least one interactive content item to assist an employee of the POS location to perform a specific duty.

8. The system of claim 1, wherein the POS interaction module is configured to allow for the selection of at least one interactive content item configured to induce a potential customer to make a purchase.

9. A non-transitory computer-readable medium having instructions that, when executed by a processor, cause the processor to perform operations for content replacement distribution, the operations comprising:
receiving a first content item from a first entity for inclusion in a library of content items;
receiving a selection of the first content item from a second entity for inclusion in a content compilation that includes a plurality of content items from the library of content items;
distributing at least some of the content items in the second entity's content compilation, including at least the first content item;
receiving, from the first entity, a modified content item to replace the first content item;
implementing an automatic content replacement in which the content compilation of the second entity is updated to include the modified content item instead of the first content item; and
redistributing at least some of the content items of the second entity's content compilation, including at least the modified content item.

10. The computer-readable medium of claim 9, wherein implementing the automatic content replacement occurs in response to the reception of the modified content item from the first entity.

11. The computer-readable medium of claim 9, wherein implementing the automatic content replacement occurs according to a predetermined update schedule subsequent to the reception of the modified content item from the first entity.

12. The computer-readable medium of claim 9, wherein implementing the automatic content replacement occurs upon reception of an update request by one of the first entity and the second entity subsequent to the reception of the modified content item from the first entity.

13. The computer-readable medium of claim 9, wherein the first content item comprises one of a coupon, a promotion, an advertisement, a rebate, and a special offering.

14. The computer-readable medium of claim 9, wherein the first content item comprises at least one of a video clip, an image, and an audio clip.

15. The computer-readable medium of claim 9, wherein the content compilation of the second entity comprises a selection of a plurality of content items from a library of content items that includes the first content item and at least one other content item.

16. The computer-readable medium of claim 15, wherein the content compilation of the second entity comprises at least one external content item outside of the first content library, the external content item distributed by a third entity that is independent from the first and second entities.

17. A content delivery system, comprising:
a processor for processing upload requests from content providers and distribution requests from content requestors;
at least one network communication component for receiving requests from content providers and content requestors;
a data store for storing data objects, including electronic content items;
a library module configured to maintain a library of uniquely identifiable electronic content items;
an upload module configured to allow each of a plurality of content providers to upload a plurality of content items to the library of electronic content items;
a selection module configured to allow for a plurality of content requestors to each select a content compilation comprising a subset of the plurality of content items from the library of content items;
a distribution module configured to distribute the content items from the library of content items to the content requestors according to the selected content compilations;
a replacement module configured to allow content providers to replace a previously uploaded content item with a replacement content item, such that the replaced content item is removed from the library of content items; and
an automatic content replacement distribution module configured to automatically update the content compilations that included the removed content item with the replacement content item, such that the replacement content item is seamlessly provided to the content requestors in place of the removed content item.

18. The content delivery system of claim 17, further comprising:
an accessibility module configured to allow the content providers to assign a level of accessibility to each content item uploaded to the library of content items via the upload module.

19. The content delivery system of claim 18, wherein the accessibility module is configured to allow a content provider to assign a level of accessibility that limits the availability of an uploaded content item to only those content requestors that have a contractual relationship with the content provider.

20. The content delivery system of claim 18, wherein the accessibility module is configured to allow a content provider to select a level of accessibility that limits the availability of an uploaded content item to only those content requestors that market at least one of a service associated with the content provider and a product associated with the content provider.

21. The content delivery system of claim 18, wherein the accessibility module is configured to allow a content provider to select a level of accessibility that limits the type of devices on which the uploaded content item may be accessed.

22. The content delivery system of claim 17, wherein content items uploaded by the content providers comprise at least one of video clips, audio clips, and images.

23. A content delivery system, comprising:
a library of uniquely identifiable electronic content items;
an upload module configured to allow an entity to upload a content item to the library of electronic content items;
a distribution module configured to selectively distribute the uniquely identifiable electronic content items to a content requestor; and
an automatic content replacement distribution module configured to allow the entity to replace one of the uniquely identifiable electronic content items with a replacement electronic content item, such that a request by a content requestor for the replaced content item is seamlessly provided with access to the replacement electronic content item.
